(19) United States
(12) Patent Application Publication
(10) Pub. No.: US 2015/0196375 A1
(43) Pub. Date: Jul. 16, 2015

(54) Saliva Ejector Construction

(71) Applicant: Gary G. Wegmann, Chicago, IL (US)

(72) Inventor: Gary G. Wegmann, Chicago, IL (US)

(21) Appl. No.: 14/156,475

(22) Filed: Jan. 16, 2014

(51) Int. Cl. A61C 17/06

(52) U.S. Cl. CPC A61C 17/043

(57) ABSTRACT

A saliva ejector construction useful in the prevention of cross-contamination and the spread of infection between dental patients through the backflow of bacteria retracted through the saliva ejector tubing of evacuation systems used in the dental operatory, said saliva ejector comprising an elongated ejector tube having a proximal end being attachable to a suction or vacuum capability having factory pre-set calibrations for removing the unwanted build-up of saliva and debris from the inside of the patient's mouth during the course of a dental procedure or operation, a distal end having a saliva ejector tip for insertion into the patient's mouth to contact the unwanted build-up of saliva and debris during the course of said dental procedure or operation, and an aperture disposed within a wall of the elongated ejector tube to control and minimize the occurrence of pressure differentials within the tubing of the evacuation system when a patient closes their lips around said saliva ejector tip placed within the patient's mouth, the aperture being a vacuum release and control aperture having a diameter of from about 0.0135 inch to about 0.038 inch so as to achieve and maintain a suction force equal to from about 79% to about 96% of the factory pre-set values of the evacuation system of the modern dental operatory.

This application is a continuation-in-part of application Ser. No. 13/715,208, filed Dec. 14, 2012.

### FIELD OF THE INVENTION

The present invention relates to saliva ejectors used in dentistry. More particularly, the present invention relates to a saliva ejector construction useful in the prevention of cross-contamination and the spread of infection between dental patients by preventing the backflow of bacteria through the tubing of saliva ejector evacuation systems while simultaneously, and essentially, maintaining the factory pre-set vacuum calibrations for the fluids and debris removal capabilities of the modern dental operatory.

### BACKGROUND OF THE INVENTION

A dental operatory is a room in a dental office or clinic where dental procedures are performed on a patient. A typical dental operatory will be equipped with (1) a patient chair that can be reclined, (2) the dentist's and assistants' chairs or stools, (3) dental hand pieces (drills), (4) an overhead dental light, (5) high- and low-volume suction tubes, (6) water hoses, and (7) x-ray equipment.

Saliva ejectors are typically attached to the end of the suction tubes which communicate with a vacuum source. These saliva ejectors are vacuum cleaners for the mouth, and are generally described as narrow tubes that dentists and other oral health professionals use to suction saliva, blood, and debris from the mouth during a dental visit. A saliva ejector generally consists of a suction tube and a disposable tip. Usually made of plastic, the device can include a flexible wire to bend it into a hook shape so that it can be inserted comfortably into a patient's mouth. The saliva ejector may sit in the mouth during a dental procedure such as filling teeth, or the dentist may insert it into the mouth at intervals during the procedure. By continuously ridding the mouth of excessive saliva and other liquids and debris, saliva ejectors keep the mouth clear for the dentist to do his or her job.

In recent years, saliva ejectors have inspired controversy. Research findings caution that a “backflow” of liquid from the ejector into the patient's mouth can occur when the pressure in the mouth is less than the pressure in the ejector. This pressure difference often occurs when a patient seals their lips around the saliva ejector tip.

Backflow is the movement of a fluid in the opposite direction than it was originally moving. In the case of the dental unit vacuum system, backflow is the flow of fluids from the vacuum line back into a patient's mouth. Suckback, a similar phenomenon, is the backflow of fluid that occurs when a patient closes their mouth on the saliva ejector and then overcomes the vacuum while re-opening their mouth. When the patient opens their mouth, they can inadvertently suck fluid from the vacuum line back into their mouth.

Backflow can occur under many situations. Research studies indicate that backflow occurs primarily when there is a fluctuation in the vacuum pressure. Fluctuations can also occur when other devices are used in the dental office or when the saliva ejector is blocked against the cheek, tongue, or other parts of a patient's mouth. The highest risk of backflow, however, exists when a patient closes their mouth on the saliva ejector.

The American Dental Association (ADA) and the Centers for Disease Control and Prevention (CDC) have recognized the possibility of cross-contamination and the spread of infection between dental patients by means of the saliva ejector as a major public health concern, and such recognition goes as far back as 1993. (See The Journal of the American Dental Association, Apr. 1, 1993, Vol. 124, No. 4) In 1996, for example, an article appearing in The Journal of the American Dental Association (JADA 1996; 127(5):611-615) discusses “Backflow in Low-Pressure Suction Lines: The Impact of Pressure Changes,” authored by G. L. Mann, T. L. Crawford, and J. J. Crawford. Further, the Oct. 1, 2013 edition of the Journal of the American Dental Association (Vol. 144, 1110-1118) decries the potential public health hazard of Hepatitis B virus transmissions associated with portable dental clinics. Still further, Chris Miller, PhD, Director of Infection Control Research and Services, and Professor of Oral Biology at Indiana University, has also recognized that backflow in low-volume suction lines may lead to potential cross-contamination and the spread of infection between dental patients.

Vacuum pumps in the dental operatory are designed to provide a vacuum source for use by dental professionals. The main purpose of the vacuum is to evacuate the oral cavity. The vacuum level of the vacuum pumps used in general dentistry and surgery are pre-set at the factory. Typically, recommended operating vacuum levels are 10 mm Hg. for general dentistry, and 19 mm Hg. for surgery. Any appreciable drop in the vacuum level of the vacuum used to evacuate the oral cavity tends to degrade the effectiveness of the evacuation of the oral cavity of the patient being treated, and, therefore, acts to diminish the effectiveness of the factory's pre-set vacuum levels for the vacuum pumps.

Vacuum pump pre-sets are calibrated for maximum effectiveness by air intake through the saliva ejector tip only. Air intake from any other source in the closed dental operatory system other than through the saliva ejector tip will act to diminish the effectiveness of the removal of debris and fluids from the patient's oral cavity. In view of these factory pre-set calibrations, it is, therefore, necessary to guard against any drop in vacuum levels so as not to render the closed evacuation system of the dental operatory virtually negligibly effective and unfit for its intended purposes.

Devices proposed in the past to alleviate this problem have proven costly to manufacture, and are of complex design. One such past attempt to facilitate a solution to this problem appears in prior art reference, U.S. Pat. No. 5,941,703, which teaches utilization of an interfacing socket into which the tube portion of an ejector is press-fitted. The interfacing socket includes a unidirectional valve with a valve body having a base and a valve diaphragm. The unidirectional valve is designed for placement between a socket channel and a controller channel, the socket channel-controller channel combination being then disposed between the ejector tip and a low-volume suction tube to form a passage through which fluid matter passes. A flexible flap is configured to flex to open position relative to the base in response to differential pressure present in the low volume suction tube to allow the passage of fluid matter through the ejector valve. The flexible flap is also configured to flex to a closed position in response to a second differential pressure present in the ejector tip. This option for the prevention of backflow or suck back when the patient closes his mouth around the saliva ejector tip, however, necessitates the provision of a device which is of complex design and expensive manufacture, thereby providing a less-than-attractive solution to this vexing public health problem.

Another attempt to facilitate a solution to this problem was revealed in Whitehouse et al, U.S. Pat. No. 5,425,637 (1995), wherein a vacuum release aperture was disposed along the length of the saliva ejector tube. While this proposed solution seemed viable upon first blush, this invention failed to specifically identify or limit the other properties of the device which would substantially prevent corruption of the closed evacuation system, nor did it teach any means to control the suction force acting through the saliva ejector tube having the vacuum release aperture.

### SUMMARY OF THE INVENTION

Accordingly, it is an object of the present invention to provide an improved dental saliva ejector construction which serves to facilitate the prevention of backflow from the tubing of saliva ejector evacuation systems due to fluctuations in vacuum pressure.

It is another object of the present invention to provide an improved saliva ejector construction which serves to control and minimize the occurrence of pressure differential shifts in the vacuum lines of the dental operatory which occur when a patient closes their lips around the tip of the saliva ejector.

It is another object of the present invention to provide an improved saliva ejector construction which serves to maintain the integrity of the evacuation system of the dental operatory while providing for the optimal control and maintenance of suction force through the saliva ejector tube.

It is yet another object of the present invention to provide a dental saliva ejector construction which is of simple design and inexpensive construction.

These and other objects of the present invention will be best understood upon a reading of the following detailed description taken in connection with the accompanying drawings, charts, and graphs which form part of the specification, with the understanding, however, that the invention is not confined to a strict conformity with same, but may be changed or modified so long as such changes and modifications constitute no material departure from the salient features of the invention as expressed in the appended claims.

### BRIEF DESCRIPTION OF THE DRAWINGS

FIG. 1 is an isometric view of a prior art saliva ejector having vertical intake slots and a baffle or disk slightly inside of the end of the tip of the device.

FIG. 2 is an isometric view of a saliva ejector of the common design of FIG. 1, and of the present invention, depicting a vacuum release and control aperture disposed in a wall thereof near its proximal end.

FIG. 3 is a table showing suction force maintenance values of a saliva ejector of a closed evacuation system of a dental operatory for vacuum prevention and suction control apertures having diameters of 1/16″ and ⅛″.

FIG. 4 is a table showing suction force maintenance values of the saliva ejector of a closed evacuation system of a dental operatory for vacuum release and suction control apertures having diameters ranging in size from 0.0135″ to 0.038″ shown in comparison with a saliva ejector having no aperture.

FIG. 5 is a graph showing the results for each aperture size given in FIG. 4 plotted along a “best fit” line using second order polynomial regression depicting the percentage of suction expected for each aperture size.

FIG. 6 is a table listing the percentage suction expected for a given aperture size compared to a saliva ejector having “no aperture.”

### DESCRIPTION OF THE PREFERRED EMBODIMENTS

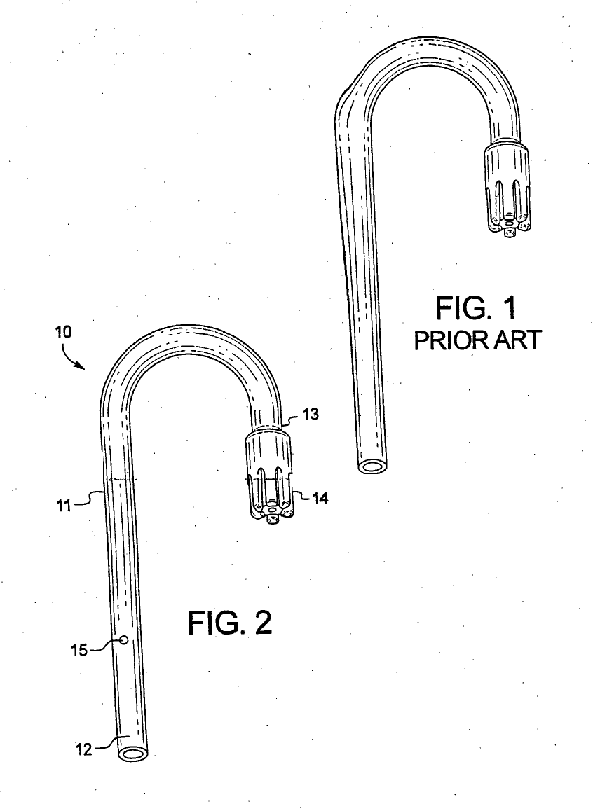

Referring now to the drawing figures, FIG. 1 depicts an isometric view of a prior art saliva ejector as may be currently utilized in the practice of dentistry.

FIG. 2 depicts an isometric view of the dental saliva ejector 10 of the present invention, and includes an elongated saliva ejector tube 11 having a proximal end 12 which is attachable to a suction or vacuum capability (not shown) for removing the unwanted build-up of saliva and debris from the inside of a patient's mouth during the course of a dental procedure or operation. The distal end 13 of saliva ejector 10 includes a saliva ejector tip 14 for insertion into the patient's mouth to contact and remove, by way of the suction or vacuum capability, any unwanted build-up of saliva and debris generated during the course of the dental procedure or operation.

Saliva ejector 10 also includes an aperture 15 disposed along the length of the elongated ejector tube 11, preferably near its proximal end 12. The disposition of the aperture 15 along the length of saliva ejector tube 11 near it proximal end 12 advantageously places it in closer proximity to the evacuation system providing the suction capability, and places it at a desirable distance from saliva ejector tip 14 which is placed in the patient's mouth.

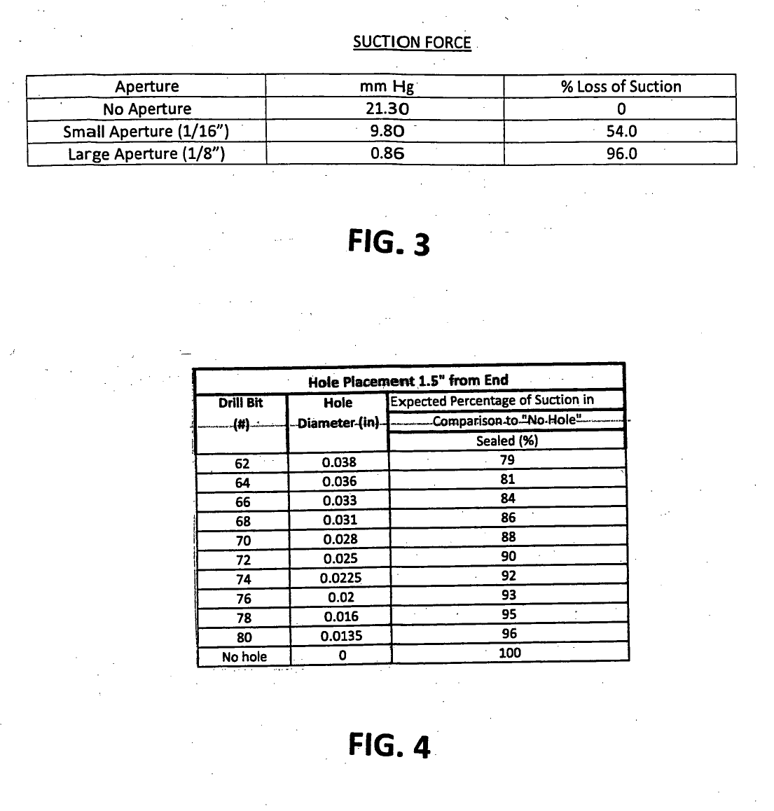

Independent experimental investigations were performed in order to determine the influence of the size of aperture 15 on the suction force of the saliva ejector 10 of the closed evacuation system of the dental operatory. Results for suction force maintenance of the factory pre-set calibrations of the closed evacuation system were calculated, respectively, for apertures ⅛″ (0.1250 inch) and 1/16″ (0.0625 inch) in diameter, and are given in the FIG. 3. The percentage loss of suction force for each aperture size, as compared with a saliva ejector with no aperture disposed along the elongated saliva ejector tube 11, is given along with pressure readings in mm of Hg. The suction force of the vacuum line was established by the suction force of the saliva ejector 10 with no aperture in a perfect seal configuration. The aperture having the smaller diameter resulted in the least amount of loss of suction force.

Inasmuch as the loss of suction force for ⅛″ and 1/16″ size apertures ranged from 54% to 96% respectively, it was determined that such losses of suction force were unacceptable, and would virtually render the effectiveness of the closed evacuation system's factory pre-set calibrations negligible and essentially unfit for its intended purposes. Testing was continued in order to obtain empirical data to determine the ideal aperture size, or size range, for the elongated saliva ejector tube 11 in order to realize an acceptable amount of suction force for efficient operation of the closed evacuation system of the dental operatory such that air intake through the saliva ejector tip 14 would not be diminished to the point of being rendered unfit for its intended purposes, particularly in view of the vacuum level pre-sets of the evacuation pumps previously set at the factory.

Aperture sizes were varied from 0.038″ to 0.0135″ in diameter. Results for the suction force for each size aperture are given in FIG. 4. Results were plotted along a “best fit” line made using second order polynomial regression as shown in FIG. 5.

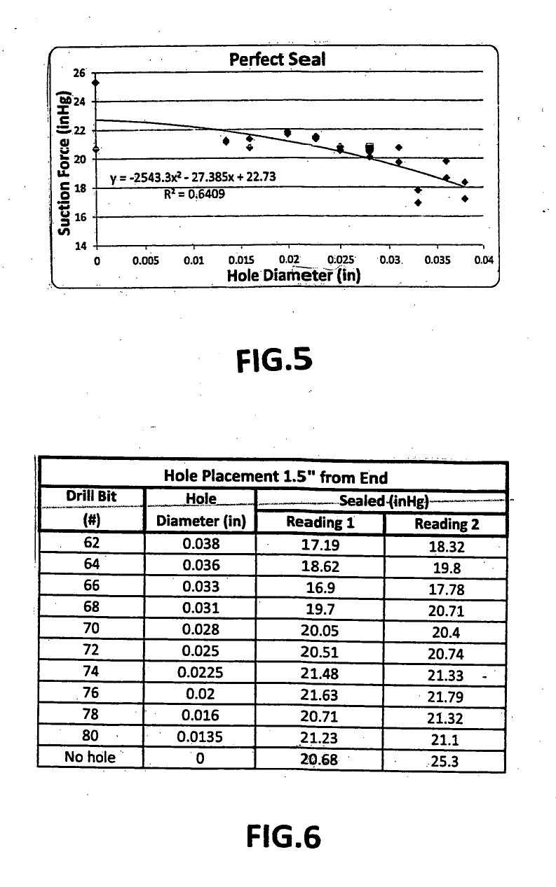

From the equation given by the “best fit” curves in FIG. 5, FIG. 6 lists the percentage of suction expected for a given size aperture in comparison to a saliva ejector with “No aperture.”

In operation, notwithstanding the fact that a wall of elongated saliva ejector tube 11 includes aperture 15, pressure equilibrium and sufficient suction capability and vacuum pressure nonetheless exists between the pressure in the patient's mouth and the pressure in the evacuator and evacuator lines to remove saliva and debris generated during the procedure or operation. When a patient closes his or her lips around saliva ejector tip 14, a seal is created and the pressure in the patient's mouth decreases such that it is less than the pressure in the evacuator and evacuator lines. This decrease in pressure initiates the creation of a partial vacuum. Due to the disposition of aperture 15 along the length of elongated saliva ejector tube 11, preferably near its proximal end 12, any vacuum created therein is advantageously released at the site of aperture 15 along the length of elongated saliva ejector tube 11, a comfortable and desirable distance from the location of saliva ejector tip 14 which is inserted in the patient's mouth. Therefore, when the patient's lips close their lips around the mouthpiece or saliva ejector tip 14, a vacuum will not develop from the seal created thereby because air from the room will be drawn through aperture 15 to equalize pressure in the evacuation system, thus, preventing the occurrence of any possible backflow. Moreover, because of the discovery of the limitation in the size of aperture 15 as serving not only to prevent the occurrence any appreciable reduction in the suction force required in the removal of fluids and debris from the mouth of the patient upon whom a dental procedure is being performed, but also in maintaining vacuum pump pre-sets as closely as possible to the ideal calibrations recommended by the factory.

It is to be understood that the present invention is not to be taken as being limited to the accompanying drawings and specification. While a particular embodiment of the present invention has been herein illustrated and described, it is not intended to limit the invention to such disclosure, but changes and modifications may be made therein and thereto.

It is also to be understood that the phraseology and terminology herein employed are for purposes of description and not of limitation, since the scope of the invention is denoted by the appended claims.

What is claimed is:

1. A saliva ejector construction useful in the prevention of cross-contamination and the spread of Infection between dental patients through the backflow of bacteria retracted through the saliva ejector tubing of evacuation systems used in the dental operatory, said saliva ejector comprising an elongated ejector tube having
(a) a proximal end being attachable to a suction or vacuum capability having factory pre-set calibrations for removing the unwanted build-up of saliva and debris from the inside of the patient's mouth during the course of a dental procedure or operation,
(b) a distal end having a saliva ejector tip for insertion into the patient's mouth to contact said unwanted build-up of saliva and debris during the course of said dental procedure or operation, and
(C) an aperture disposed within a wall of said elongated ejector tube to control and minimize the occurrence of pressure differentials within said tubing of said evacuation system when a patient closes their lips around said saliva ejector tip placed within said patient's mouth, said aperture being a vacuum release and control aperture having a diameter of from about 0.0135 inch to about 0.038 inch.

2. The saliva ejector construction of claim 1, wherein said aperture is disposed within a wall of said elongated ejector tube near its proximal end.

3. The saliva ejector construction of claim 1, wherein said aperture disposed within said wall of said elongated saliva ejector tube may be disposed at any point along its length.

4. The saliva ejector construction of claim 1, wherein said aperture disposed within said wall of said elongated saliva ejector tube is a vacuum release and control aperture.

5. (canceled)

6. The saliva ejector construction of claim 1, wherein said vacuum release and control aperture is sized so as to achieve and maintain a suction force equal to from about 79% to about 96% of the factory pre-set values of said evacuation system of said dental operatory.
